(19) United States
(12) Patent Application Publication
(10) Pub. No.: US 2025/0050825 A1
(43) Pub. Date: Feb. 13, 2025

(54) METHODS AND SYSTEMS FOR A TURBO SHIELD

(71) Applicant: YOUSSEF DANDACHLI, Austin, TX (US)

(72) Inventor: YOUSSEF DANDACHLI, Austin, TX (US)

(21) Appl. No.: 18/929,258

(22) Filed: Oct. 28, 2024

Related U.S. Application Data
(63) Continuation of application No. PCT/US23/27017, filed on Jul. 6, 2023.
(60) Provisional application No. 63/389,158, filed on Jul. 14, 2022.

(51) Int. Cl. B60R 13/08; B32B 5/02; B32B 5/26; B32B 7/022; F02B 39/00; F02B 77/11

(52) U.S. Cl. CPC B60R 13/0838; B32B 5/022; B32B 5/024; B32B 5/028; B32B 5/275; B32B 7/022; F02B 39/00; F02B 77/11; B32B 2262/108; B32B 2307/304; B32B 2307/546; B32B 2605/00

(57) ABSTRACT

A turbo shield with a mesh screen, wherein the screen is configured to provide structure and protection to woven fibers, and to passively control heat dissipation. By varying the covering and thicknesses of the mesh screen as well as the thickness of insulation layer, the air flow created by turbocharger may be passively controlled.

### BACKGROUND INFORMATION

### Field of the Disclosure

Examples of the present disclosure are related to systems and methods for a turbo shield. Specifically, embodiments are related to a turbo shield with mesh screen, wherein the mesh screen is configured to protect a woven mesh screen while allowing the fabric to be exposed for heat dissipation properties.

### Background

Heat shields in vehicles are designed to protect electronic packages, sensors, wiring, engines, and other vehicle components from contacting and/or emitting substantial amount of heat. For example, a heat shield may be utilized to cover a turbocharger, exhaust manifold, exhaust piping, engine, catalytic converter, etc., wherein these components may generate a substantial amount of heat.

Turbo shields are configured to elevate the performance of vehicles by providing heat protection and reducing turbo lag to a turbocharger. Conventional turbo shields are form fitted around a turbocharger, and utilize carbon fibers to retain heat inside of the turbo. This causes the exhaust gases inside the turbocharger to become hotter, enabling the turbocharger to spool up more quickly. The carbon fibers are either positioned within a rigid metal casing, or are exposed to the elements. Insulators with hard metal casings are not breathable. Alternatively, conventional turbo shields with exposed woven fibers are vulnerable to the elements and are stretched when positioned on the turbo engines.

Accordingly, needs exist for more efficient and effective turbo shields a breathable mesh screen positioned over a woven mesh, wherein the mesh screen is configured to protect the woven fibers from the elements while also disappointing heat.

### SUMMARY

Embodiments described herein are directed towards systems and methods for a turbo shield that is configured to be efficiently removed and recoupled to a turbocharger without degrading the fibers associated with the turbo shield. The turbo shield may include a body, woven fibers, mesh screen, insulation, first rivet, second rivet.

The body of the turbo shield may be configured to house and secure the other elements of the turbo shield together. The body may be substantially annular in shape, and have an inner circumference and an outer circumference. The body of the turbo shield may be configured to isolate the heat produced by a turbocharger with the purpose of reducing turbo lag, cooler air intake temperatures, protecting and prolonging vital under hood components, and give a boost in horse power.

The body may include a front face, rear face, and a curved surface. The front face and the rear face may each include first portion, second portion, and a slit, wherein the slit separates the first portion from the second portion. The first portion may include a first edge and second edge, and the second portion may include a third edge and a fourth edge. The first portion and the second portion may be configured to be separated from each other at two locations, wherein the first location is between free ends of the first portion and the second portion and the second location is across a hinge aligned with the outer circumference of the body. This may enable the body to be positioned over the turbo charger without stretching the woven fibers. In embodiments, the first edge and the third edge may be free ends configured to be moved away from each other to increase a distance from the first edge and the third edge, wherein there is no piece of material directly connecting the first edge to the third edge.

The slit may be positioned between the second edge and the fourth edge, wherein the slit forms a hinge or axis of rotation aligned with the outer circumference of the body. The slit may extend from the inner circumference of the body towards the outer circumference of the body to form the hinge positioned on the outer circumference of the body. The hinge may enable the second edge and the fourth edge to be rotated away from each other. In embodiments, when the body is positioned on a turbo charger the second edge and the fourth edge may be positioned adjacent to each other, and when it is desired to remove the turbo shield from the turbocharger the angle between the third edge and the fourth edge may be greater than one hundred eighty degrees. In embodiments, a length of the slit may be slightly less than a distance between the outer circumferences of the body to the inner circumference of the body, and be greater than a thickness of the insulation layer.

The curved surface may be positioned between the front face and the rear face. The curved surface may directly connect the outer circumference of the front face and the rear face, over an entirety of the outer circumferences. The curved surface may be a continuous surface, without a change in materials, and extend through and around the slid and the second and fourth edges. The continuous curved surface may enable heat to be uniformly dissipated.

The woven fibers may be formed of any material that can be woven into tight woven fibers. For example, the woven fibers may form an outer layer of the body and be formed of pulverized volcanic lava rock (Rated 1800° F. Direct Heat/2500° F. Radiant Heat). In embodiments, the woven fibers may be any material that stretching causes the material to break down, which reduces their heat retention capabilities. For example, the woven fibers may be a stainless steel mesh. In embodiments, the woven fibers may be positioned on an outer layer of the base.

The mesh screen may be configured to be positioned over the woven fibers on the front face, rear face, and curved surface. The mesh screen may be uniformly formed, and be configured to protect the woven fibers from external elements while also allowing heat dissipation through the mesh screen. Furthermore, the mesh screen may be configured to give the turbo shield strength and structure, while not blocking heat transfer or over insulating the woven fibers. Specifically, if the outer layer of the mesh screen was formed of metal, the woven fibers would retain the heat, causing the woven fibers to break down. In embodiments, the mesh screen may be configured to cover around fifty percent of the surface area of the woven fibers.

The insulation may be insulating wool, such as calcium magnesium silicate wool. The insulation may be configured to retain the heat produced by the turbocharger within the turbo shield.

The first rivet may be a projection positioned on the first portion of the body proximate to the first edge. The second rivet may be a projection positioned on the second portion of the body proximate to the third edge. In use, a coupling mechanism, such as a spring or clamp, may utilize the first rivet and the second rivet to secure the body around a turbocharger. This may create a linear force across the body on an opposite side of the body as the slit, wherein the linear force extends in a first axis that is perpendicular to a second axis associated with a length of the slit.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present embodiments are described with reference to the following figures, wherein like reference numerals refer to like parts throughout the various views unless otherwise specified.

FIG. 1 depicts a turbo shield, according to an embodiment.

FIG. 2 depicts a method of using a turbo shield, according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Embodiments described herein are directed towards systems and methods for a heat shield configured to be removably coupled to a turbocharger without degrading the woven fibers associated with the turbo shield.

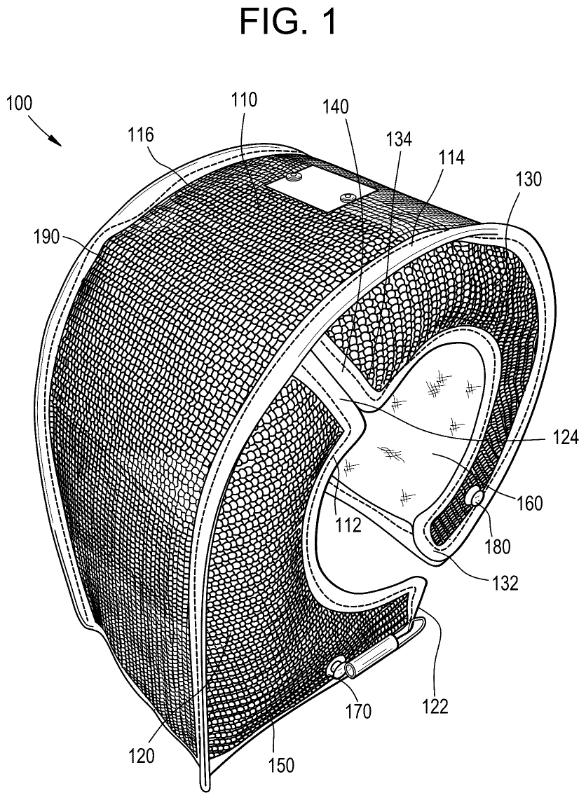

Turning now to FIG. 1, FIG. 1 depicts one embodiment of a turbo shield 100. Turbo shield 100 may include a body 110, woven fibers 150, insulation 160, first rivet 170, and second rivet 180.

Body 110 of turbo shield 100 may be configured to house and secure the other elements of the turbo shield 100 together. Body 110 may have an annular shape, with an inner circumference 112 and an outer circumference 114. In embodiments, the inner circumference 112 and outer circumference 114 may dynamically change in shape and size to change the overall contour and outline of body 110. This may enable inner circumference 112 and outer circumference 114 to increase in size to be positioned around a turbo charger without stretching woven fibers, and then to subsequently decrease in size to secure body 110 to a turbo charger. Body 110 may include a first portion 120 with first edge 122 and second edge 124, and second portion 130 with third edge 132 and fourth edge 134. First portion 120 and second portion 130 may be configured to be separated at two different locations.

A first location of separation may be between first edge 122 and third edge 132, wherein first edge 122 and third edge 132 are free ends that are not coupled together. When first edge 122 and third edge 132 are pulled apart there may be an open space extending across multiple different planes. Through the opening created between first edge 122 and third edge 132 a turbocharger may be positioned within the inner circumference 112 of body 110.

The second location of separation between first portion 120 and second portion 130 may be at slit 140. Slit 140 may be positioned between the second edge 124 and the fourth edge 134, wherein second edge 124 and fourth edge 132 are not free ends. Slit 140 may extend from inner circumference 112 towards the outer circumference 114 to form a hinge 142 positioned on the outer circumference 114. In embodiments, an axis of rotation created by hinge 142 may extend from a front face of body 110 to a rear face of body 110. The hinge 142 formed by the slit 140 may enable the second edge 124 and the fourth edge 134 to be rotated away from each other while the outer ends of second edge 124 and fourth edge 134 remain in close contact and a distance between the inner ends of second edge 124 and fourth edge 134 increases. In embodiments due to hinge 142 there will be constant contact between first portion 110 and second portion 120, which is unlike the complete opening formed across the first location.

In embodiments, when body 110 is positioned on a turbo charger the second edge 124 and the fourth edge 134 may be positioned adjacent to each other, and when it is desired to remove the turbo shield 100 from the turbocharger the angle between the second edge 124 and fourth edge 134 may gradually increase to be greater than one hundred eighty degrees. This may enable an outer surface of second portion 120 to be rotated and positioned adjacent to an outer surface first portion 130, without stretching woven fibers 130. In embodiments, a length of the slit 140 may be slightly less than a distance between the outer circumferences 114 to the inner circumference 112, and be greater than a thickness of the insulation layer 160. Furthermore, when the body is positioned over a turbo charger, second edge 124 and fourth edge 134 may be overlaid on top of each other, or may be positioned directly adjacent to each other across slit 140.

Body 110 may also include a curved surface 116 that extends from a front face of the turbo shield 100 to a rear face of the turbo shield along a lateral axis, and along the outer circumference 114. Body 110 may be a continuous surface, and be configured to extend over an axis of rotation of first portion 120 and second portion 130. Curve surface 116 may enable the outer surface of body 110 to be substantially uniform, which may assist in heat being more uniformly dissipated. Specifically, if body 110 included a hinge directly coupling first portion 120 and second portion 130 made of different materials or different thickness of materials than other portion of body 110, then the separable hinge may not uniformly dissipate the heat. This may cause a heat buildup around the hinge, damaging the woven fibers close to the hinge. Additionally, in embodiments, an insulation layer 160 may be positioned on the front face and the rear face that has a different thickness than that of an insulation layer 160 positioned on the curved surface 116. This may change the heat dissipation towards the front and rear faces, away from the curved surface 116. Accordingly, more heat may be dissipated in a plane that is in parallel to opening on inner circumference 112 than an angle orthogonal from the inner circumference 112.

Woven fibers 150 may be formed of any material that can be woven into a tight woven fibers, and form an outer surface of body 110. Woven fibers 150 may be positioned on a front face, rear face, and curved surface of body 110—extending from first edge 122 to third edge 132. Woven fibers 150 may be formed of pulverized volcanic lava rock (Rated 1800° F. Direct Heat/2500° F. Radiant Heat). In embodiments, the woven fibers 150 may be any material that is negatively impacted by stretching, wherein the stretching causes the material associated with woven fibers 150 to break down and reduces the heat retention capabilities of the material. For example, the woven fibers 150 may be a stainless steel mesh. In embodiments, a thickness of the woven fibers 150 may be the same on the front face, rear face, and curved surface 116 of body 110.

Mesh screen 190 may be a barrier of connected strands of metal, fiber, or other flexible or ductile materials. In embodiments, a material of mesh screen may be more rigid and durable than that of woven fibers 150. Mesh screen 190 may be directly overlaid on woven fibers 150 on the front face, rear face, and curved surface 116, and form an outer barrier to turbo shield 110. The mesh screen 190 may be configured to protect woven fibers 150 from the elements while also allowing for controlling heat dissipation. In embodiments, when mesh screen 190 is positioned over woven fibers 150, the first portion 120 and second portion 130 may not be able to rotate one hundred eighty degrees due to the structure provided by mesh screen 190. For example, first portion 120 may only be able to rotate ninety degrees relative to second portion 130.

In embodiments, mesh screen 190 may be uniformly positioned over woven fibers 150 on the front face, rear face, and curved surface 116. Accordingly, each of the front face, rear face, and curved surface 116 may have a same pattern mesh, wherein mesh screen may cover between twenty five to seventy percent of the faces and curved surface 116. This coverage may be configured to allow for heat dissipation. Alternatively, a complete coverage would limit the dissipation of heat and retain the heat within body 110, which would lead to break down of woven fibers.

In other embodiments, mesh screen 190 may be not be uniformly positioned over woven fibers 150 on the front face, rear face, and curved surface 116. Accordingly, the front face may have a different mesh pattern with a different surface coverage than that of the rear face and/or curved surface 116, the rear face may have a different mesh pattern with a different surface coverage than that of the front face and/or the curved surface 116, or curved surface 116 may have a different mesh pattern with a different surface coverage than that of the rear face and/or the front face. By modifying the coverage and/or mesh pattern between curved surface 116 and the front face and rear face, embodiments may allow more heat dissipation in angles orthogonal or parallel to that of a central axis of inner circumference 112. For example, if a first mesh screen 190 positioned on the front face and rear face of covered seventy percent of the surfaces and a second mesh screen 190 positioned on curved surface 116 covered twenty five percent of the curved surface 116, then more heat may travel along a path towards curved surface 116 due to it being covered by less material.

In other embodiments, mesh screen 116 may be formed of connected strands that have different thicknesses. The thicknesses of the mesh screen 116 may be different on the curved surface, wherein the thickest portion of the mesh screen 116 on the curved surface may be along central axis of the curved surface 116. The central axis of the curved surface 116 may extend along the external circumference of the turbo shield 100. This may enable heat to be dissipated away from the intake and outlet of the turbocharger, in a plane orthogonal to the exhaust outlet.

By varying the covering and thicknesses of the mesh screen 190 as well as the thickness of insulation layer 160, the air flow created by turbocharger may be passively controlled.

The insulation layer 160 may be insulated wool, such as calcium magnesium silicate wool. The insulation layer 160 may be configured to retain the heat produced by the turbocharger within the turbo shield 100. In embodiments, the insulation layer 160 may be positioned on an internal surface of body 110, and the stretching of the insulation may or may not impact the insulation properties of the insulation layer 170. As such, insulation layer 160 may be formed of a much more pliable material than the woven fibers 150. In embodiments, insulation layer 160 may have a first thickness on the front face and rear face, and a second thickness on curved surface 116 of body 110, wherein the second thickness is greater than the first thickness, and is less than a length of slit 140.

The first rivet 170 may be a projection positioned on the first portion 120 of the body 110 proximate to the first edge 122. The second rivet 180 may be a projection positioned on the second portion 130 proximate to the third edge 132. In use, a coupling mechanism, such as a spring or clamp, may utilize the first rivet 170 and the second rivet 180 to secure the body 110 around a turbocharger. The external coupling mechanism may create a linear force across the body 110 on an opposite side of the body as the slit, wherein the linear force extends in a first axis that is perpendicular to a second axis associated with a length of the slit 140.

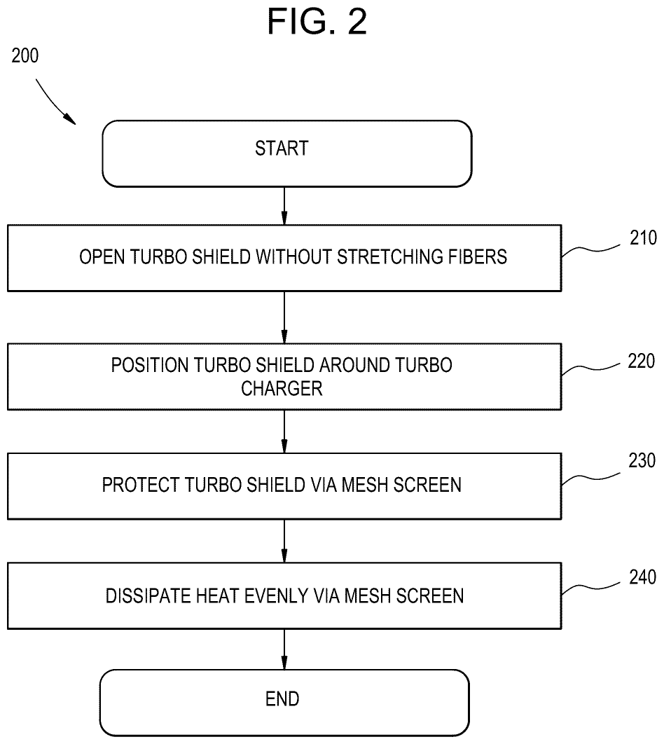

In implementations, the bottom opening of turbo shield 100 may be moved/stretching apart such that first edge 122 and third edge 132 are positioned away from each other to accommodate a turbocharger. The bottom opening may be increased to a substantial length due to slit 140 allowing second edge 124 and fourth edge 134 to be positioned away from each other. As shown in FIG. 2, the location of slit 140 may be aligned in a plane to be within the opening created between first edge 122 and third edge 132. This may allow a length of the bottom opening to be maximized without stretching mesh weave 150.

FIG. 2 depicts a method for removable coupling a turbo shield from a turbocharger, according to an embodiment. The operations of the method presented below are intended to be illustrative. In some embodiments, the method may be accomplished with one or more additional operations not described, and/or without one or more of the operations discussed. Additionally, the order in which the operations of the method are illustrated in FIG. 2 and described below is not intended to be limiting.

At operation 210, a first portion of a turbo shield may be rotated away from a second portion of the turbo shield. An axis of rotation may be formed via a slit extending from an inner circumference of the body towards the outer circumference of the body of the turbo shield. Specifically, inner edges of the first portion and the second portion of the turbo shield may be rotated around the axis of rotation to create a space between the inner edges, wherein the angle associate with the hinge may be greater than ninety degrees. This may allow a bottom opening to be formed between external edges of the first portion and the second portion that not directly coupled together. In embodiments, when the first portion and the second portion are rotated away from each other, a woven fibers on the external surface of the first portion and the second portion may not be stretched.

At operation 220, the turbo shield may be positioned around turbocharger by sliding an open bottom end between external edge of the first portion around the turbocharger.

At operation 230, the turbo shield may be protected by the mesh screen positioned over the woven fibers.

At operation 240, the mesh screen may allow for uniform heat dissipation. Specifically, a layering of the insulation and the thickness and coverage of the mesh screen may passively control the heat dissipation created by the turbocharger.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

The flowcharts and block diagrams in the flow diagrams illustrate the architecture, functionality, and operation of possible implementations of systems, methods, and computer program products according to various embodiments of the present invention. It will also be noted that each block of the block diagrams and/or flowchart illustrations, and combinations of blocks in the block diagrams and/or flowchart illustrations, may be implemented in different orderings, combinations, etc., with additional blocks and/or blocks removed.

What is claimed is:

1. A system to passively control heat for automobiles comprising:
a turbo shield configured to protect components within an engine bay of a vehicle;
a mesh screen positioned over the turbo shield, wherein the mesh screen is configured to passively control heat generated by a turbo charger within the vehicle.

2. The system of claim 1, wherein the turbo shield includes a woven fiber layer and an insulation layer, the mesh screen being more rigid than the woven fiber layer, the woven fiber layer and the mesh screen being formed of pliable materials.

3. The system of claim 2, wherein the turbo shield includes a front face, a rear face, and a curved surface, wherein the curved surface is positioned between the front face and the rear face, the front face include an inner circumference and an outer circumference, a slit extends from the inner circumference towards the outer circumference and allowing a first portion of the front face to rotate away from a second portion of the front face.

4. The system of claim 3, wherein a coverage of the mesh screen is uniform on the front face, the rear face, and the curved surface.

5. The system of claim 3, wherein the mesh screen includes a first mesh screen configured to cover the front face, and a second mesh screen configured to cover the curved surface.

6. The system of claim 5, wherein the first mesh screen has more openings in one linear inch than the second mesh screen.

7. The system of claim 5, wherein the first mesh screen has fewer openings in one linear inch than the second mesh screen.

8. The system of claim 5, wherein a first thickness of the first mesh screen is larger than a second thickness of the second mesh screen.

9. The system of claim 5, wherein a second thickness of the second mesh screen is larger than a first thickness of the first mesh screen.

10. The system of claim 3, the first portion having a first edge at a free end and a second edge adjacent to the slit, the second portion having a third edge at a free end and a fourth edge adjacent to the slit, wherein a first location of separation between the first edge and third edge, and the slit forms a second location of separation between the second edge and the fourth edge.

11. The system of claim 10, wherein the slit forms an axis of rotation between the first portion and the second portion.
